(19) United States
(12) Patent Application Publication
(10) Pub. No.: US 2026/0134277 A1
(43) Pub. Date: May 14, 2026

(54) Method, System, and Computer Program Product for Multitask Learning on Time Series Data

(71) Applicant: Visa International Service Association, San Francisco, CA (US)

(72) Inventors: Michael Yeh, Newark, CA (US); Xin Dai, Fremont, CA (US); Yan Zheng, Los Gatos, CA (US); Junpeng Wang, Santa Clara, CA (US); Yujie Fan, Cleveland Heights, OH (US); Huiyuan Chen, San Jose, CA (US); Zhongfang Zhuang, San Jose, CA (US); Liang Wang, San Jose, CA (US); Wei Zhang, Fremont, CA (US)

(21) Appl. No.: 19/118,437

(22) PCT Filed: Oct. 5, 2023
(86) PCT No.: PCT/US23/34504

§ 371 Date: Apr. 4, 2025

Related U.S. Application Data
(60) Provisional application No. 63/413,722, filed on Oct. 6, 2022.

(51) Int. Cl. G06N 3/08; G06N 3/0464; G06N 3/048

(52) U.S. Cl. CPC G06N 3/08; G06N 3/0464; G06N 3/048

(57) ABSTRACT

Provided are methods for generating a multitask machine learning model based on time series data, that may include receiving input time series data associated with an input time series of data points, calculating a pairwise distance between the input time series and a plurality of time series templates, providing the pairwise distance as a first input to a building block of a residual neural network, where the residual neural network has a plurality of multi-dimensional convolutional layers; generating a first output of the first building block of the residual neural network based on the first input, generating a final output of the residual neural network based on the first output, and generating a first output of a multitask machine learning model using a first output layer and a second output of the multitask machine learning model using a second output layer. Systems and computer program products are also disclosed.

### CROSS-REFERENCE TO RELATED APPLICATIONS

This application is the United States national phase of International Application No. PCT/US23/34504 filed Oct. 5, 2023, and claims priority to U.S. Provisional Patent Application No. 63/413,722, filed on Oct. 6, 2022, the disclosures of which are hereby incorporated by reference in their entireties.

### BACKGROUND

### 1. Technical Field

The disclosed subject matter relates generally to methods, systems, and products for machine learning in multiple task environments and, in some particular embodiments or aspects, to methods, systems, and computer program products for generating multitask machine learning models using multitask learning on time series data.

### 2. Technical Considerations

Certain systems may use multitask learning (MTL) models. For example, a deep neural network (DNN) model may include a plurality of layers including an input layer, at least one hidden layer (e.g., a single hidden layer, a plurality of hidden layers, and/or the like), and at least one output layer. For MTL models, at least some of the hidden layer(s) (and/or the input layer) of the DNN model may be shared between multiple tasks, and each task may have associated therewith at least one output layer (e.g., separate from the output layer(s) of other tasks). For example, sharing layers (e.g., hidden layers, input layers, etc.) may include hard parameter sharing (HPS) and/or the like.

However, the use of time series data with MTL models may be difficult. For example, as MTL models involve multiple tasks (e.g., predictions and/or the like) being performed by one model, it may be challenging to evaluate the features (e.g., the importance of the features, the performance of the model based on the features, the impact of the features, and/or the like) because different features may have different impact (e.g., relevance, predictive power, and/or the like) for different tasks. Moreover, difficulty may be encountered when handling the conflicts among the learning goals of different tasks. In some instances, attempts to solve this problem include alleviating the conflicts of gradients with respect to task losses. However, this provides difficulties with training models in an effective amount of time, using efficient amounts of resources, and achieving desirable accuracy in results.

### SUMMARY

Accordingly, provided are improved methods, systems, and computer program products for generating multitask machine learning models using multitask learning on time series data.

According to non-limiting embodiments or aspects, provided is a computer-implemented method for generating a multitask machine learning model based on time series data, including receiving input time series data associated with an input time series of data points. The method may further include calculating a pairwise distance between the input time series and each time series template of a plurality of time series templates. The method may further include providing the pairwise distance as a first input to a first building block of a plurality of building blocks of a residual neural network. The residual neural network may have a plurality of multi-dimensional convolutional layers. The method may further include generating a first output of the first building block of the residual neural network based on the first input. The method may further include providing the first output as a second input to a second building block of the plurality of building blocks of the residual neural network. The method may further include generating a final output of the residual neural network based on the second input. The method may further include providing the final output of the residual neural network as an input to each output layer of a plurality of output layers of a multitask machine learning model. The plurality of output layers may include a first output layer associated with a first classification task of the multitask machine learning model and a second output layer associated with a second classification task of the multitask machine learning model. The method may further include generating a first output of a multitask machine learning model using the first output layer and a second output of the multitask machine learning model using the second output layer.

According to non-limiting embodiments or aspects, provided is a system for generating a multitask machine learning model based on time series data, including at least one processor programmed or configured to receive input time series data associated with an input time series of data points. The at least one processor may be further programmed or configured to calculate a pairwise distance between the input time series and each time series template of a plurality of time series templates, wherein, when calculating the pairwise distance between the input time series and each time series template of the plurality of time series templates, the at least one processor is programmed or configured to: calculate the pairwise distance between each data point of the input time series and each value of each time series template of the plurality of time series templates. The at least one processor may be further programmed or configured to provide the pairwise distance as a first input to a first building block of a plurality of building blocks of a residual neural network. The residual neural network may have a plurality of multi-dimensional convolutional layers. The at least one processor may be further programmed or configured to generate a first output of the first building block of the residual neural network based on the first input. The at least one processor may be further programmed or configured to provide the first output as a second input to a second building block of the plurality of building blocks of the residual neural network. The at least one processor may be further programmed or configured to generate a final output of the residual neural network based on the second input. The at least one processor may be further programmed or configured to provide the final output of the residual neural network as an input to each output layer of a plurality of output layers of a multitask machine learning model. The plurality of output layers may include a first output layer associated with a first classification task of the multitask machine learning model and a second output layer associated with a second classification task of the multitask machine learning model. The at least one processor may be further programmed or configured to generate a first output of a multitask machine learning model using the first output layer and a second output of the multitask machine learning model using the second output layer.

According to non-limiting embodiments or aspects, provided is a computer program product for generating a multitask machine learning model based on time series data, the computer program product including at least one non-transitory computer-readable medium including one or more instructions that, when executed by at least one processor, cause the at least one processor to receive input time series data associated with an input time series of data points. The one or more instructions may further cause the at least one processor to calculate a pairwise distance between each data point of the input time series and each time series template of a plurality of time series templates. The one or more instructions may further cause the at least one processor to provide the pairwise distance as a first input to a first building block of a plurality of building blocks of a residual neural network. The residual neural network may have a plurality of multi-dimensional convolutional layers. The one or more instructions may further cause the at least one processor to generate a first output of the first building block of the residual neural network based on the first input. The one or more instructions may further cause the at least one processor to provide the first output as a second input to a second building block of the plurality of building blocks of the residual neural network. The one or more instructions may further cause the at least one processor to generate a final output of the residual neural network based on the second input. The one or more instructions may further cause the at least one processor to provide the final output of the residual neural network as an input to each output layer of a plurality of output layers of a multitask machine learning model. The plurality of output layers may include a first output layer associated with a first classification task of the multitask machine learning model and a second output layer associated with a second classification task of the multitask machine learning model. The one or more instructions may further cause the at least one processor to generate a first output of a multitask machine learning model using the first output layer and a second output of the multitask machine learning model using the second output layer.

Further non-limiting embodiments or aspects are set forth in the following numbered clauses:
Clause 1: A computer-implemented method for generating a multitask machine learning model based on time series data, comprising: receiving, with at least one processor, input time series data associated with an input time series of data points; calculating, with at least one processor, a pairwise distance between the input time series and each time series template of a plurality of time series templates; providing, with at least one processor, the pairwise distance as a first input to a first building block of a plurality of building blocks of a residual neural network, wherein the residual neural network has a plurality of multi-dimensional convolutional layers; generating, with at least one processor, a first output of the first building block of the residual neural network based on the first input; providing, with at least one processor, the first output as a second input to a second building block of the plurality of building blocks of the residual neural network; generating, with at least one processor, a final output of the residual neural network based on the second input; providing, with at least one processor, the final output of the residual neural network as an input to each output layer of a plurality of output layers of a multitask machine learning model, wherein the plurality of output layers comprises: a first output layer associated with a first classification task of the multitask machine learning model, and a second output layer associated with a second classification task of the multitask machine learning model; and generating, with at least one processor, a first output of a multitask machine learning model using the first output layer and a second output of the multitask machine learning model using the second output layer.
Clause 2: The computer-implemented method of clause 1, wherein a building block of the plurality of building blocks of the residual neural network comprises: a plurality of two dimensional convolutional layers; and a plurality of layers having a rectified linear unit activation function.
Clause 3: The computer-implemented method of clause 1 or 2, wherein an output layer of the plurality of output layers comprises: a layer having a linear activation function, and a layer having a softmax activation function.
Clause 4: The computer-implemented method of any of clauses 1-3, wherein each output layer of the plurality of output layers has an independent set of parameters associated with a classification task of the output layer.
Clause 5: The computer-implemented method of any of clauses 1-4, wherein the input time series has a first length, wherein each time series template of the time series templates has a second length, wherein the plurality of time series templates comprises a number of time series templates, and wherein calculating the pairwise distance between each data point of the input time series and each time series template of the plurality of time series templates comprises: computing a pairwise distance matrix that has a width equal to the second length, a height equal to the first length, and a length equal to the number of time series templates.
Clause 6: The computer-implemented method of any of clauses 1-5, wherein generating the final output of the residual neural network comprises: generating an output of a global average pooling layer based on an input to the global average pooling layer, wherein the input to the global average pooling is based on the second input to the second building block of the residual neural network.
Clause 7: The computer-implemented method of any of clauses 1-6, further comprising: training the multitask machine learning model based on a loss function, wherein the loss function is associated with a stochastic gradient (SGD) algorithm.
Clause 8: A system for generating a multitask machine learning model based on time series data, comprising at least one processor programmed or configured to: receive input time series data associated with an input time series of data points; calculate a pairwise distance between the input time series and each time series template of a plurality of time series templates, wherein, when calculating the pairwise distance between the input time series and each time series template of the plurality of time series templates, the at least one processor is programmed or configured to: calculate the pairwise distance between each data point of the input time series and each value of each time series template of the plurality of time series templates; provide the pairwise distance as a first input to a first building block of a plurality of building blocks of a residual neural network, wherein the residual neural network has a plurality of multi-dimensional convolutional layers; generate a first output of the first building block of the residual neural network based on the first input; provide the first output as a second input to a second building block of the plurality of building blocks of the residual neural network; generate a final output of the residual neural network based on the second input; provide the final output of the residual neural network as an input to each output layer of a plurality of output layers of a multitask machine learning model, wherein the plurality of output layers comprises: a first output layer associated with a first classification task of the multitask machine learning model, and a second output layer associated with a second classification task of the multitask machine learning model; and generate a first output of a multitask machine learning model using the first output layer and a second output of the multitask machine learning model using the second output layer.
Clause 9: The system of clause 8, wherein a building block of the plurality of building blocks of the residual neural network comprises: a plurality of two dimensional convolutional layers; and a plurality of layers having a rectified linear unit activation function.
Clause 10: The system of clause 8 or 9, wherein an output layer of the plurality of output layers comprises: a layer having a linear activation function, and a layer having a softmax activation function.
Clause 11: The system of any of clauses 8-10, wherein each output layer of the plurality of output layers has an independent set of parameters associated with a classification task of the output layer.
Clause 12: The system of any of clauses 8-11, wherein the input time series has a first length, wherein each time series template of the time series templates has a second length, wherein the plurality of time series templates comprises a number of time series templates, and wherein, when calculating the pairwise distance between each data point of the input time series and each time series template of the plurality of time series templates, the at least one processor is programmed or configured to: compute a pairwise distance matrix that has a width equal to the second length, a height equal to the first length, and a length equal to the number of time series templates.
Clause 13: The system of any of clauses 8-12, wherein, when generating the final output of the residual neural network, the at least one processor is programmed or configured to: generate an output of a global average pooling layer based on an input to the global average pooling layer, wherein the input to the global average pooling is based on the second input to the second building block of the residual neural network.
Clause 14: The system of any of clauses 8-13, wherein the at least one processor is further programmed or configured to: train the multitask machine learning model based on a loss function, wherein the loss function is associated with a stochastic gradient (SGD) algorithm.
Clause 15: A computer program product for generating a multitask machine learning model based on time series data, the computer program product comprising at least one non-transitory computer-readable medium including one or more instructions that, when executed by at least one processor, cause the at least one processor to: receive input time series data associated with an input time series of data points; calculate a pairwise distance between the input time series and each time series template of a plurality of time series templates; provide the pairwise distance as a first input to a first building block of a plurality of building blocks of a residual neural network, wherein the residual neural network has a plurality of multi-dimensional convolutional layers; generate a first output of the first building block of the residual neural network based on the first input; provide the first output as a second input to a second building block of the plurality of building blocks of the residual neural network; generate a final output of the residual neural network based on the second input; provide the final output of the residual neural network as an input to each output layer of a plurality of output layers of a multitask machine learning model, wherein the plurality of output layers comprises: a first output layer associated with a first classification task of the multitask machine learning model, and a second output layer associated with a second classification task of the multitask machine learning model; and generate a first output of a multitask machine learning model using the first output layer and a second output of the multitask machine learning model using the second output layer.
Clause 16: The computer program product of clause 15, wherein a building block of the plurality of building blocks of the residual neural network comprises: a plurality of two dimensional convolutional layers; and a plurality of layers having a rectified linear unit activation function.
Clause 17: The computer program product of clause 15 or 16, wherein an output layer of the plurality of output layers comprises: a layer having a linear activation function, and a layer having a softmax activation function.
Clause 18: The computer program product of any of clauses 15-17, wherein each output layer of the plurality of output layers has an independent set of parameters associated with a classification task of the output layer.
Clause 19: The computer program product of any of clauses 15-18, wherein the input time series has a first length, wherein each time series template of the time series templates has a second length, wherein the plurality of time series templates comprises a number of time series templates, and wherein the one or more instructions that cause the at least one processor to calculate the pairwise distance between each data point of the input time series and each time series template of the plurality of time series templates cause the at least one processor to: compute a pairwise distance matrix that has a width equal to the second length, a height equal to the first length, and a length equal to the number of time series templates.
Clause 20: The computer program product of any of clauses 15-19, wherein the one or more instructions that cause the at least one processor to generate the final output of the residual neural network cause the at least one processor to: generate an output of a global average pooling layer based on an input to the global average pooling layer, wherein the input to the global average pooling is based on the second input to the second building block of the residual neural network.

These and other features and characteristics of the presently disclosed subject matter, as well as the methods of operation and functions of the related elements of structures and the combination of parts and economies of manufacture, will become more apparent upon consideration of the following description and the appended claims, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which methods, systems, and/or computer program products, described herein, may be implemented according to the principles of the presently disclosed subject matter;

FIG. 2 is a diagram of a non-limiting embodiment or aspect of components of one or more devices of FIG. 1;

FIG. 3 is a flowchart of a non-limiting embodiment or aspect of a process for generating multitask machine learning models using multitask learning on time series data;

FIG. 4 is a diagram of a residual neural network machine learning model according to some non-limiting embodiments or aspects; and

FIGS. 5A-5F are diagrams of non-limiting embodiments or aspects of an implementation of a process for generating multitask machine learning models using multitask learning on time series data according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term “token service provider” may refer to an entity including one or more server computers in a token service system that generates, processes and maintains payment tokens. For example, the token service provider may include or be in communication with a token vault where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to payment device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “computing device” may refer to one or more electronic devices that are configured to directly or indirectly communicate with or over one or more networks. A computing device may be a mobile device, a desktop computer, and/or any other like device. Furthermore, the term “computer” may refer to any computing device that includes the necessary components to receive, process, and output data, and normally includes a display, a processor, a memory, an input device, and a network interface. As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

The term “processor,” as used herein, may represent any type of processing unit, such as a single processor having one or more cores, one or more cores of one or more processors, multiple processors each having one or more cores, and/or other arrangements and combinations of processing units.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the disclosed subject matter are directed to methods, systems, and computer program products for generating multitask machine learning models using multitask learning on time series data. In some non-limiting embodiments or aspects, a machine learning management system may include at least one processor programmed or configured to receive input time series data associated with an input time series of data points, calculate a pairwise distance between each data point of the input time series and each time series template of a plurality of time series templates, provide the pairwise distance as a first input to a first building block of a plurality of building blocks of a residual neural network, where the residual neural network has a plurality of multi-dimensional convolutional layers, generate a first output of the first building block of the residual neural network based on the first input, provide the first output as a second input to a second building block of the plurality of building blocks of the residual neural network, generate a final output of the residual neural network based on the second input, provide the final output of residual neural network as an input to each output layer of a plurality of output layers of a multitask machine learning model, where the plurality of output layers comprises: a first output layer associated with a first classification task of the multitask machine learning model, and a second output layer associated with a second classification task of the multitask machine learning model, and generate a first output of a multitask machine learning model using the first output layer and a second output of the multitask machine learning model using the second output layer.

In some non-limiting embodiments or aspects, a building block of the plurality of building blocks of the residual neural network comprises a plurality of two dimensional convolutional layers and a plurality of layers having a rectified linear unit activation function. In some non-limiting embodiments or aspects, an output layer of the plurality of output layers comprises a layer having a linear activation function and a layer having a softmax activation function. In some non-limiting embodiments or aspects, each output layer of the plurality of output layers has an independent set of parameters associated with a classification task of the output layer.

In some non-limiting embodiments or aspects, the input time series has a first length, wherein each time series template of the time series templates has a second length, wherein the plurality of time series templates comprises a number of time series templates, and when calculating the pairwise distance between each data point of the input time series and each time series template of the plurality of time series templates, the at least one processor is programmed or configured to compute a pairwise distance matrix that has a width equal to the second length, a height equal to the first length, and a length equal to the number of time series templates.

In some non-limiting embodiments or aspects, the time series of historical data points may be represented by a tensor. For example, the tensor may be an n×m×k tensor, where n is a width equal to the second length, m is a height equal to the first length, and k is a length equal to the number of time series templates.

In some non-limiting embodiments or aspects, neural network machine learning model may use a 3×3 conv, with a stride size (e.g., 2) after each block to halve the width, n, and/or the height, m, of an intermediate representation.

In some non-limiting embodiments or aspects, when generating the final output of the residual neural network, the at least one processor is programmed or configured to generate an output of a global average pooling layer based on an input to the global average pooling layer, wherein the input to the global average pooling is based on the second input to the second building block of the residual neural network. In some non-limiting embodiments or aspects, the at least one processor is further programmed or configured to train the multitask machine learning model based on a loss function, wherein the loss function is associated with a stochastic gradient (SGD) algorithm.

In this way, the machine learning management system may allow for generating multitask machine learning models that are trained with time series data. The machine learning management system may provide for a reduction in the amount of time to generate multitask machine learning models, which use reduced amounts of network resources, and achieving increased accuracy in regard to tasks of the multitask machine learning models, including time series classification tasks.

For the purpose of illustration, in the following description, while the presently disclosed subject matter is described with respect to methods, systems, and computer program products for multitask learning on time series data, e.g., for processing payment transactions, one skilled in the art will recognize that the disclosed subject matter is not limited to the non-limiting embodiments or aspects disclosed herein. For example, the methods, systems, and computer program products described herein may be used with a wide variety of settings, such as multitask learning on time series data using neural networks in any suitable setting, e.g., predictions, regressions, classifications, fraud prevention, authorization, authentication, identification, feature selection, and/or the like.

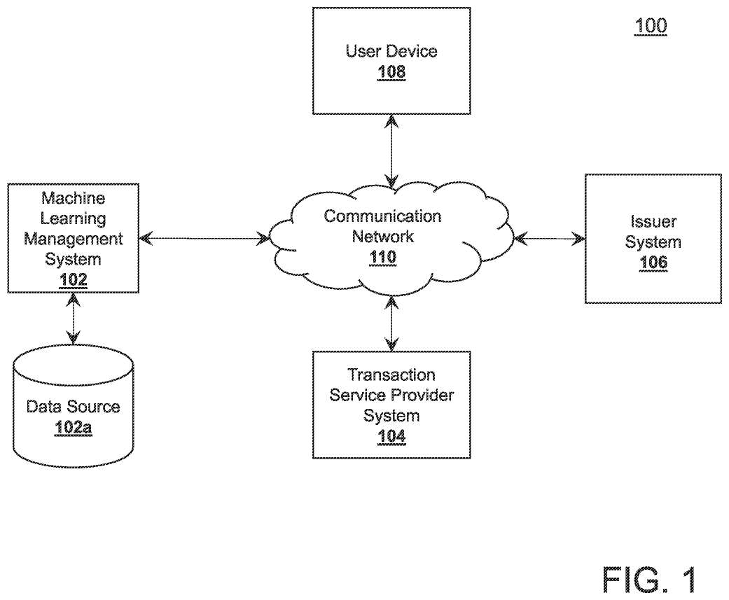

Referring now to FIG. 1, FIG. 1 is a diagram of an example environment 100 in which devices, systems, and/or methods, described herein, may be implemented. As shown in FIG. 1, environment 100 includes machine learning management system 102, data source 102a, transaction service provider system 104, issuer system 106, user device 108, and communication network 110. Machine learning management system 102, data source 102a, transaction service provider system 104, issuer system 106, and/or user device 108 may interconnect (e.g., establish a connection to communicate) via wired connections, wireless connections, or a combination of wired and wireless connections.

Machine learning management system 102 may include one or more devices configured to communicate with transaction service provider system 104, issuer system 106, and/or user device 108 via communication network 110. For example, machine learning management system 102 may include a server, a group of servers, and/or other like devices. In some non-limiting embodiments or aspects, machine learning management system 102 may be associated with issuer system 106. For example, machine learning management system 102 may be operated by issuer system 106. In another example, machine learning management system 102 may be a component of issuer system 106. In some non-limiting embodiments or aspects, machine learning management system 102 may be in communication with data source 102a, which may be local or remote to machine learning management system 102. In some non-limiting embodiments or aspects, machine learning management system 102 may be capable of receiving (e.g., retrieving via a pull) information from, storing information in, transmitting information to, and/or searching information stored in data source 102a.

Transaction service provider system 104 may include one or more devices configured to communicate with machine learning management system 102, issuer system 106, and/or user device 108 via communication network 110. In some non-limiting embodiments or aspects, transaction service provider system 104 may include a server, a group of servers, and/or other like devices. In some non-limiting embodiments or aspects, transaction service provider system 104 is associated with an issuer. For example, transaction service provider system 104 may be operated by an issuer.

Issuer system 106 may include one or more devices configured to communicate with machine learning management system 102, transaction service provider system 104, and/or user device 108 via communication network 110. For example, issuer system 106 may include a computing device, such as a server, a group of servers, and/or other like devices. In some non-limiting embodiments or aspects, issuer system 106 may be associated with a transaction service provider system.

User device 108 may include a computing device configured to communicate with machine learning management system 102, transaction service provider system 104, and/or issuer system 106 via communication network 110. For example, user device 108 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 108 may be associated with a user (e.g., an individual operating user device 108).

Communication network 110 may include one or more wired and/or wireless networks. For example, communication network 110 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

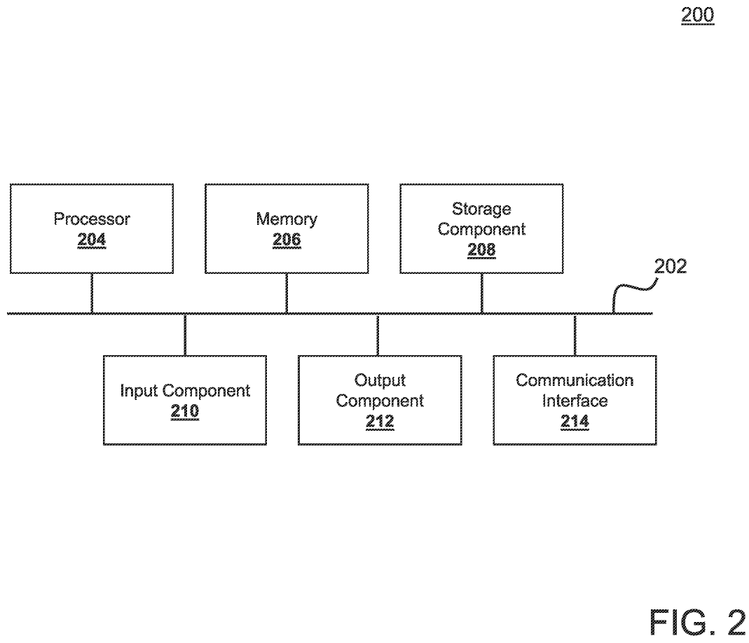

Referring now to FIG. 2, FIG. 2 is a diagram of example components of a device 200. Device 200 may correspond to one or more devices of machine learning management system 102 (e.g., one or more devices of machine learning management system 102), transaction service provider system 104 (e.g., one or more devices of transaction service provider system 104), and/or user device 106. In some non-limiting embodiments or aspects, machine learning management system 102, transaction service provider system 104, and/or user device 106 may include at least one device 200 and/or at least one component of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

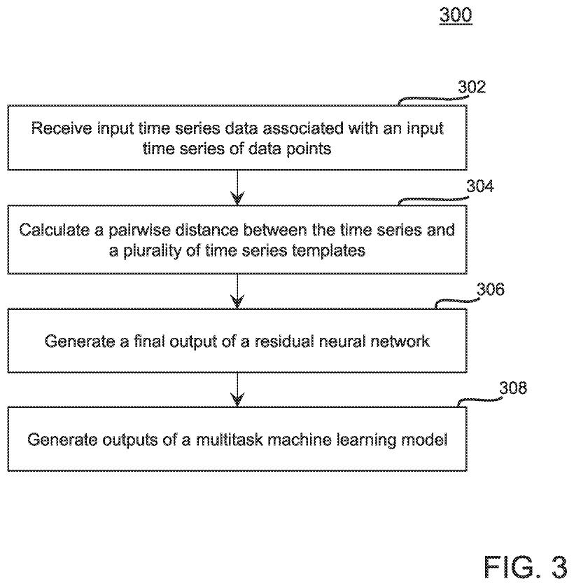

Referring now to FIG. 3, FIG. 3 is a flowchart of a non-limiting embodiment or aspect of a process 300 for generating a multitask machine learning model based on time series data. In some non-limiting embodiments or aspects, one or more of the steps of process 300 may be performed (e.g., completely, partially, etc.) by machine learning management system 102 (e.g., one or more devices of machine learning management system 102). In some non-limiting embodiments or aspects, one or more of the steps of process 300 may be performed (e.g., completely, partially, etc.) by another device or a group of devices separate from or including machine learning management system 102 (e.g., one or more devices of machine learning management system 102), transaction service provider system 104 (e.g., one or more devices of transaction service provider system 104), and/or user device 106.

As shown in FIG. 3, at step 302, process 300 includes receiving input time series data associated with an input time series of data points. For example, machine learning management system 102 may receive input time series data associated with an input time series of data points (e.g., a plurality of data instances of a sequence). In some non-limiting embodiments or aspects, model management system 102 may receive one or more input time series of data points, such as a plurality of input time series of data points. In some non-limiting embodiments or aspects, model management system 102 may receive the one or more input time series of data points from data source 102a. Additionally or alternatively, model management system 102 may receive the one or more input time series of data points from transaction service provider system 104, issuer system 106, and/or user device 108. In some non-limiting embodiments or aspects, the input time series of data points may include a time series of historical data points. In some non-limiting embodiments or aspects, the input time series may include a plurality of data points associated with a plurality of features. In some non-limiting embodiments or aspects, the plurality of data points may represent a plurality of transactions (e.g., electronic payment transactions) conducted by one or more accountholders (e.g., one or more users, such as a user associated with user device 108).

In some non-limiting embodiments or aspects, each data point may include transaction data associated with the transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a PIN, etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, machine learning management system 102 may receive the time series of historical data points from transaction service provider system 104. In some non-limiting embodiments or aspects, the time series of historical data points may include data (e.g., transaction data) associated with historical payment transactions that were conducted using one or more payment processing networks (e.g., one or more payment processing networks associated with transaction service provider system 104).

In some non-limiting embodiments or aspects, the time series of historical data points may include a multivariate time series. In some non-limiting embodiments or aspects, a multivariate time series may be a series of values that is based on a plurality of time-dependent variables, where each variable depends on that variable's past values and also has a dependency based on the other time-dependent variables of the plurality of time-dependent variables.

In some non-limiting embodiments or aspects, the time series of historical data points may be represented by a tensor. For example, the tensor may be an n×m×k tensor, where n is a width equal to the second length, m is a height equal to the first length, and k is a length equal to the number of time series templates.

In some non-limiting embodiments or aspects, a neural network machine learning model may use a 3×3 conv, with a stride size (e.g., 2) for each block to halve the width, n, and/or the height, m, of an intermediate representation.

As shown in FIG. 3, at step 304, process 300 includes calculating a pairwise distance between the time series and a plurality of time series templates. For example, machine learning management system 102 may calculate a pairwise distance between the data points and values of each time series template of a plurality of time series templates. In some non-limiting embodiments or aspects, machine learning management system 102 may calculate a pairwise distance between each data point of the input time series and each time series template of a plurality of time series templates. In some non-limiting embodiments or aspects, each time series template of the plurality of time series templates may include a learnable time series template. In some non-limiting embodiments or aspects, the input time series may have a first length, each time series template of the time series templates may have a second length, and/or the plurality of time series templates may include a number of time series templates.

In some non-limiting embodiments or aspects, machine learning management system 102 may compute a pairwise distance matrix that has a width equal to the second length, a height equal to the first length, and/or a length equal to the number of time series templates.

In some non-limiting embodiments or aspects, machine learning management system 102 may generate and/or store a tensor. For example, if a length of a first input time series is n and a length of a second input time series is m, a pairwise distance matrix of the first input time series and the second input time series may be stored as a tensor with a size of n×m×1, where k=1.

In some non-limiting embodiments or aspects, machine learning management system 102 may learn a warping mechanism based on the pairwise distance matrix. In some non-limiting embodiments or aspects, the pairwise distance matrix may include data for computing, by machine learning management system 102, the distance between the first time series and the second time series under all possible warping paths. For example, if the length of the first input time series n is equal to the length of the second input time series m (i.e., n=m), then the sum of a diagonal of the pairwise distance matrix may be a distance between the first time series and the second time series (e.g., the Euclidean distance between the first time series and the second time series). The Euclidean distance may calculate based on a distance between every data point of the first time series and every data point of the second time series.

In some non-limiting embodiments or aspects, machine learning management system 102 may calculate a dynamic time warping (DTW) distance and/or a soft-DTW distance. For example, machine learning management system 102 may calculate the DTW distance between the first time series and the second time series based on the following DTW algorithm:

```
Input: pairwise distance matrix X ∈ [symbol]   ^{n×m}
function DISTANCE(X)
  for i in [0, ... , n) do
    for j in [0, ... , m) do
      X [i, j] ← X [i, j] + RECURSION(
        X [i − 1, j], X [i, j − 1], X [i − 1, j − 1])
return X [n − 1, m − 1]
```

In some non-limiting embodiments or aspects, machine learning management system 102 may determine a multitask learning (MTL) variant of a residual neural network based on a single input time series. In some non-limiting embodiments or aspects, machine learning management system 102 may determine the MTL variant based on a number of the plurality of time series templates (e.g., k=64) and a length of the plurality of time series templates (e.g., m=512).

In some non-limiting embodiments or aspects, machine learning management system 102 may calculate the DTW distance and/or the soft-DTW distance by applying a dynamic programming recursion on the pairwise distance matrix between the first input time series and the second input time series. In some non-limiting embodiments or aspects, the recursion of the DTW distance may be based on the following function: RECURSION (x₀, x₁, x₂)=MIN (x₀, x₁, x₂). In some non-limiting embodiments or aspects, the recursion of the soft-DTW distance may be based on the following function:

$$RECURSION ( {x}_{0} , {x}_{1} , {x}_{2} ) = - γ {\sum }_{i = 1}^{3} {e}^{- {x}_{i} / γ} ,$$

where y is a hyper parameter for the soft-DTW distance. In some non-limiting embodiments or aspects, the role of the residual neural network may be similar to the recursion of the DTW distance and/or the recursion of the soft-DTW distance.

In some non-limiting embodiment or aspects, machine learning management system 102 may learn a plurality of recursion functions (e.g., warping mechanisms). In some non-limiting embodiments or aspects, machine learning management system 102 may approximate one or more variants of the DTW distance function and/or the soft-DTW distance function.

As shown in FIG. 3, at step 306, process 300 includes generating a final output of a residual neural network. For example, machine learning management system 102 may generate a final output of a residual neural network. In some non-limiting embodiments or aspects, the residual neural network may include a plurality of multi-dimensional convolutional layers (e.g., 2D convolutional layers, 3D convolutional layers, etc.).

In some non-limiting embodiments or aspects, machine learning management system 102 may provide the pairwise distance as a first input to a first building block of a plurality of building blocks of the residual neural network. In some non-limiting embodiments or aspects, machine learning management system 102 may generate a first output of the first building block of the residual neural network based on the first input. In some non-limiting embodiments or aspects, machine learning management system 102 may provide the first output as a second input to a second building block of the plurality of building blocks of the residual neural network. In some non-limiting embodiments or aspects, machine learning management system 102 may generate a final output of the residual neural network based on the second input. In some non-limiting embodiments or aspects, machine learning management system 102 may generate an output of a global average pooling layer based on an input to the global average pooling layer, where the input to the global average pooling is based on the second input to the second building block of the residual neural network.

In some non-limiting embodiments or aspects, the plurality of building blocks of the residual neural network may include 8 building blocks. In some non-limiting embodiments or aspects, a building block of the plurality of building blocks of the residual neural network may include a plurality of two-dimensional convolutional layers and/or a plurality of layers having a rectified linear unit activation function.

As shown in FIG. 3, at step 308, process 300 includes generating outputs of a multitask machine learning model. For example, machine learning management system 102 may generate outputs of a multitask machine learning model. In some non-limiting embodiments or aspects, machine learning management system 102 may provide the final output of residual neural network as an input to each output layer of a plurality of output layers of a multitask machine learning model. In some non-limiting embodiments or aspects, the plurality of output layers may include a first output layer associated with a first classification task of the multitask machine learning model and a second output layer associated with a second classification task of the multitask machine learning model.

In some non-limiting embodiments or aspects, the plurality of output layers may include a plurality of parallel output layers for each classification task. In some non-limiting embodiments or aspects, parameters associated with the multitask machine learning model and the template may be shared across each classification task.

In some non-limiting embodiments or aspects, an output layer of the plurality of output layers may include a layer having a linear activation function and a layer having a softmax activation function. In some non-limiting embodiments or aspects, each output layer of the plurality of output layers may have an independent set of parameters associated with a classification task of the output layer.

In some non-limiting embodiments or aspects, machine learning management system 102 may generate a first output of a multitask machine learning model using the first output layer and a second output of the multitask machine learning model using the second output layer.

In some non-limiting embodiments or aspects, machine learning management system 102 may train the multitask machine learning model. For example, machine learning management system 102 may train the multitask machine learning model based on a loss function. In some non-limiting embodiments or aspects, the loss function is associated with (e.g., based on) a stochastic gradient (SGD) algorithm.

In some non-limiting embodiments or aspects, the loss function may be based on a mean square error between the ground truth and the prediction.

In some non-limiting embodiments or aspects, machine learning management system 102 may modify the SGD algorithm based on the number of the plurality of time series and the length of the plurality of time series for each task to produce a modified SGD algorithm (e.g., a modified standard mini-batch SGD algorithm). For example, a standard mini-batch SGD algorithm may be based on the following function, where D is a number of dataset, n_{batch} is a batch size, nepoch is a number of epochs, and M represents the multitask machine learning model:

| function TRAIN(D, n_{batch}, n_{epoch}, M) | |
|---|---|
| nᵢₜₑᵣ ← 0 | |
| for each D in D do | |
| n_{D} ← \|D\| / n_{batch} | |
| nᵢₜₑᵣ ← MAX(nᵢₜₑᵣ, n_{D}) | |
| for i in [0, ... , n_{epoch}) do | |
| for each D in D do | |
| SHUFFLE(D) | |
| for j in [0, ... , nᵢₜₑᵣ) do | |
| SHUFFLE(D) | [symbol] shuffle the order of task |

```
      for each D in D do
        X, Y ← GETNEXTMINIBATCH(D)
        if reaching the end of D then
          SHUFFLE(D)
          restart the mini-batch counter for D
        M ← UPDATEMODEL(X, Y, M)
  return M
```

In some non-limiting embodiments or aspects, machine learning management system 102 may determine a dataset, D, of the plurality of datasets which is the largest dataset of the plurality of datasets (e.g., which dataset has the most data points). In some non-limiting embodiments or aspects, a remainder of the plurality of datasets may be a plurality of datasets which are smaller than the largest dataset (e.g., datasets having fewer data points than the largest dataset).

In some non-limiting embodiments or aspects, machine learning management system 102 may determine a number of iterations for each epoch based on a task of the plurality of tasks with the largest dataset (e.g., for each D in D do n_{d}←|D|/n_{batch}, nᵢₜₑᵣ←MAX(nᵢₜₑᵣ, n_{D}).

In some non-limiting embodiments or aspects, when a task of the plurality of tasks with a dataset smaller than the largest dataset reaches the last example while constructing SGD mini-batches, machine learning management system 102 may shuffle the dataset (e.g., if reaching the end of D, then SHUFFLE (D), and restart the mini-batch counter for D) and the mini-batch counter will be reset.

In some non-limiting embodiments or aspects, a task with a dataset smaller than the largest dataset may be sampled more than once in an epoch and/or the task with the largest dataset may be sampled once in each epoch. For example, if a number of time series for a first task is 1,000 and a number of series of a second task is 500, and the batch size is 100, then a number of iterations for each epoch is 10. In such an example, the time series for the first task may only be sampled, by machine learning management system 102, once in an epoch and/or the time series for the second task may be sampled twice in an epoch.

In some non-limiting embodiments or aspects, machine learning management system 102 may determine a length of a time series based on a task. In some non-limiting embodiments or aspects, machine learning management system 102 may assign a time series to a mini-batch based on the length of the time series and/or based on the task associated with the time series. In some non-limiting embodiments or aspects, all of the time series in a mini-batch may have the same length and/or all of the time series in a mini-batch may be associated with the same task. In some non-limiting embodiments or aspects, all examples in a batch may be associated with (e.g., come from) a dataset (e.g., a plurality of data points) associated with the same task.

In some non-limiting embodiments or aspects, machine learning management system 102 may arrange the tasks in a mini-batch in an order (e.g., first, second, third, etc.) In some non-limiting embodiments or aspects, the order of the tasks of the mini-batch may be different for each iteration. For example, the order of the tasks may be different for each iteration to ensure that the machine learning model is updated efficiently.

In some non-limiting embodiments or aspects, machine learning management system 102 may perform an action based on the classification label of an input provided by a multitask machine learning model. For example, machine learning management system 102 may perform an action based on a classification label of an input provided to one or more output layers of a plurality of output layers of a multitask machine learning model. In some non-limiting embodiments or aspects, machine learning management system 102 may perform a procedure associated with protection of an account of a user (e.g., a user associated with user device 106) based on the classification label of the input. For example, if the classification label of the input indicates that the procedure is necessary, machine learning management system 102 may perform the procedure associated with protection of the account of the user. In such an example, if the classification label of the input indicates that the procedure is not necessary, machine learning management system 102 may forego performing the procedure associated with protection of the account of the user. In some non-limiting embodiments or aspects, machine learning management system 102 may execute a fraud protection procedure based on the classification label of the input.

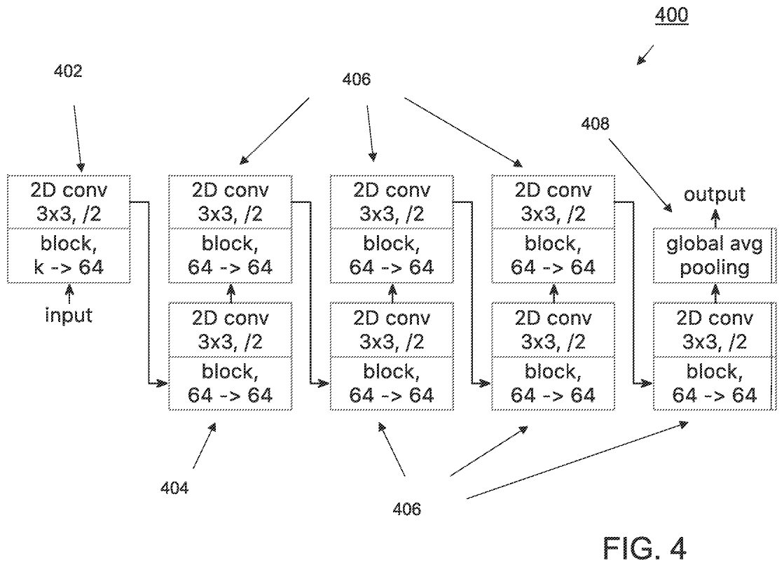

Referring now to FIG. 4, FIG. 4 is diagram of residual neural network machine learning model 400. As shown in FIG. 4, residual neural network machine learning model 400 may include a plurality of building blocks, such as 8 building blocks. For example, residual neural network machine learning model 400 may include first building block 402, second building block 404, and a plurality of additional building blocks 406. In some non-limiting embodiments or aspects, the number of additional building blocks 406 may be based on a particular application of residual neural network machine learning model 400. As further shown in FIG. 4, residual neural network machine learning model 400 may include output layer 408. In some non-limiting embodiments or aspects, each of first building block 402, second building block 404, and/or any additional building block 406 may include a plurality of two-dimensional convolutional layers and/or a plurality of layers having a rectified linear unit activation function. In some non-limiting embodiments or aspects, an input size of each of first building block 402, second building block 404, and/or any additional building block 406 may be based on a time series template of a plurality of time series templates. For example, the input size of each of first building block 402, second building block 404, and/or any additional building block 406 may be based on a number of values in a time series template and/or a number of time series templates included in the plurality of time series templates. In some non-limiting embodiments or aspects, output layer 408 may include a global average pooling layer.

In some non-limiting embodiments or aspects, residual neural network machine learning model 400 may be configured to receive an n×m×k tensor, where n is a length of a first input time series is, where m is a length of a second input time series, and where k is a number of time series templates. For example, first building block 402 may receive the n×m×k tensor.

In some non-limiting embodiments or aspects, residual neural network machine learning model 400 may include 8 blocks (e.g., first building block 402, second building block 404, and 6 additional building blocks 406). In some non-limiting embodiments or aspects, residual neural network machine learning model 400 may use a conv with a stride size after each block to modify the intermediate representation after each block of the 8 blocks. For example residual neural network machine learning model 400 may use a 3×3 conv and a stride size 2 after each block of the 8 blocks to reduce the height/width of the intermediate representation by half (e.g., 2D conv 3×3,/2).

In some non-limiting embodiments or aspects, at first building block 402, residual neural network machine learning model 400 may be configured to reduce a first intermediate representation by half using a 3×3 conv and a stride size of 2, to provide a second intermediate representation. The second intermediate representation may be input to second building block 404. At second building block 404, residual neural network machine learning model 400 may reduce the second intermediate representation by half using a 3×3 conv and a stride size of 2, to provide a third intermediate representation. The third intermediate representation may be received by an additional building block 406. At additional building block 406, residual neural network machine learning model 400 may reduce the third intermediate representation by half using a 3×3 conv and a stride size of 2, to provide a fourth intermediate representation. In some non-limiting embodiments or aspects, residual neural network machine learning model 400 may be configured to reduce the fourth intermediate representation by half using a 3×3 conv and a stride size of 2 to provide subsequent intermediate representations which may be further reduced by half.

In some non-limiting embodiments or aspects, residual neural network machine learning model 400 may be configured to generate (e.g., machine learning management system 102 may use residual neural network machine learning model 400) an output based on at least one subsequent intermediate representation. For example, the global average pooling layer may receive the at least one subsequent intermediate representation from additional building blocks 406 and/or generate an output based on the at least subsequent intermediate representation.

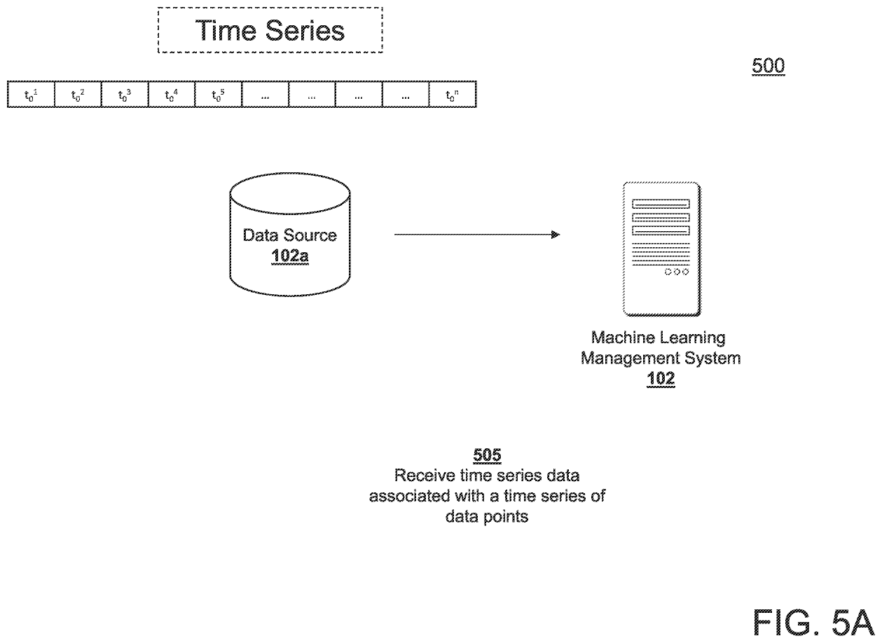

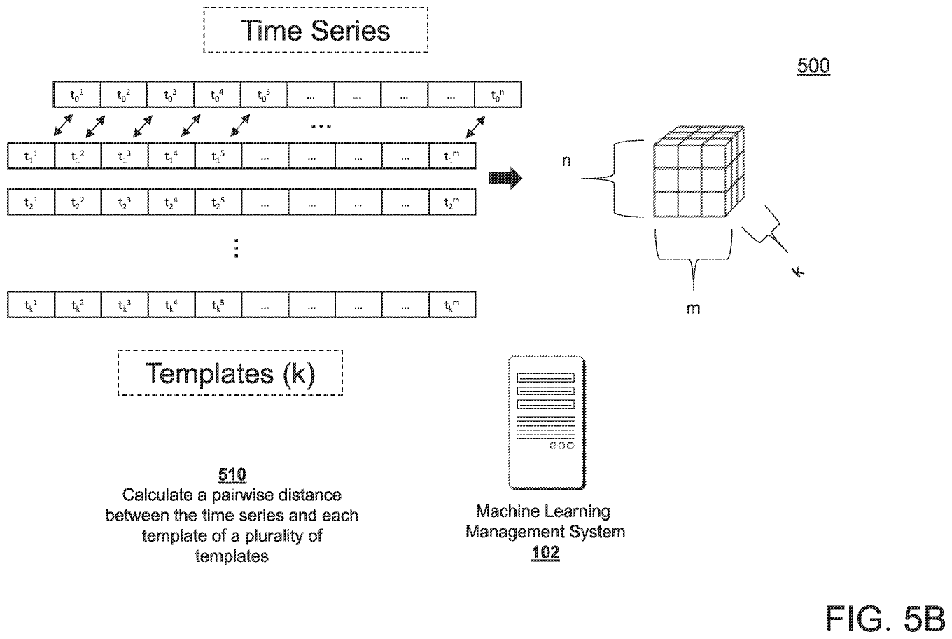

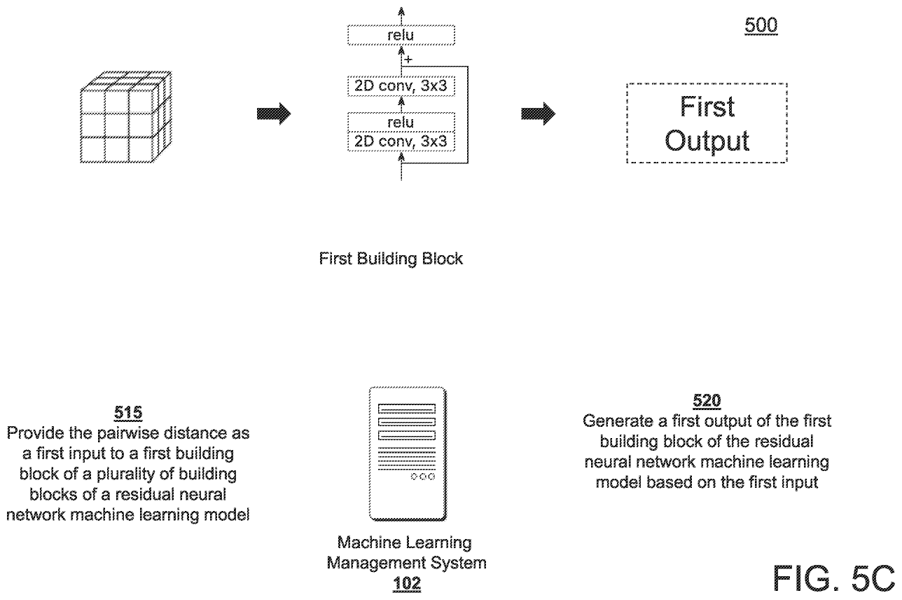

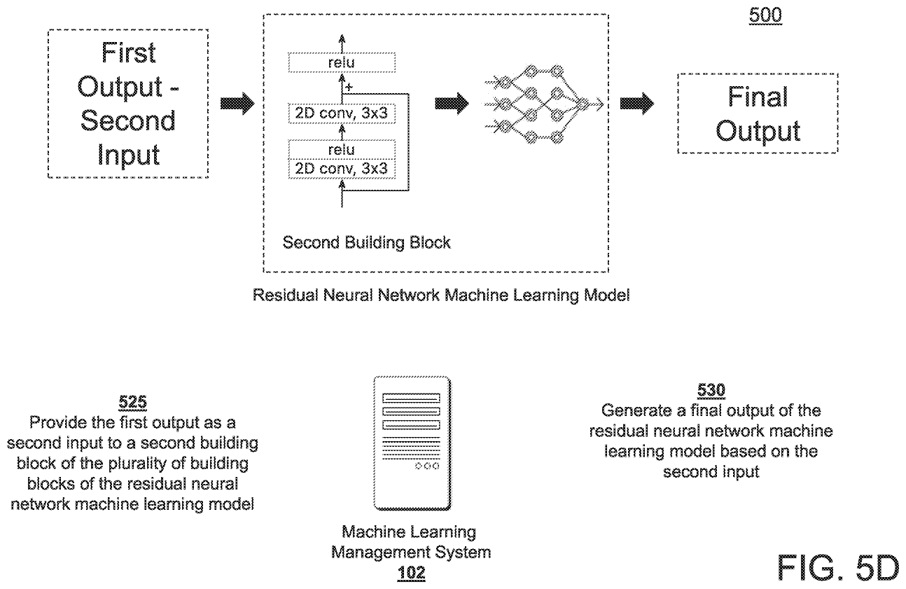

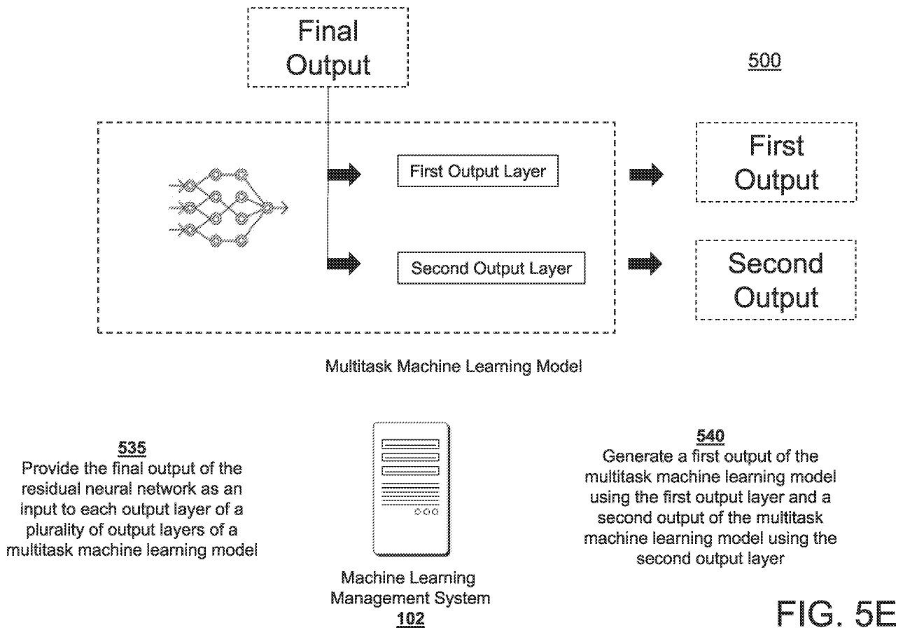

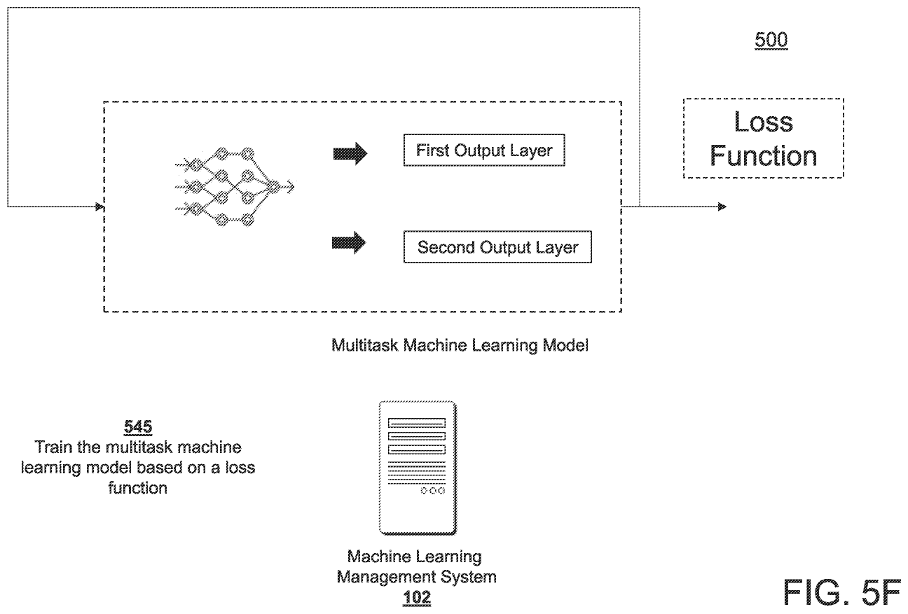

Referring now to FIGS. 5A-5F, FIGS. 5A-5F are diagrams of a non-limiting embodiment or aspect of implementation 500 relating to a process (e.g., process 300) for filtering incorrect classifications to increase machine learning model accuracy. In some non-limiting embodiments or aspects, one or more of the steps of the process may be performed (e.g., completely, partially, etc.) by machine learning management system 102 (e.g., one or more devices of machine learning management system 102). In some non-limiting embodiments or aspects, one or more of the steps of the process may be performed (e.g., completely, partially, etc.) by another device or a group of devices separate from or including machine learning management system 102 (e.g., one or more devices of machine learning management system 102), transaction service provider system 104 (e.g., one or more devices of transaction service provider system 104), issuer system 106 (e.g., one or more devices of issuer system 106), and/or user device 108.

As shown by reference number 505 in FIG. 5A, machine learning management system 102 may receive time series data associated with a time series of data points (e.g., an input time series shown as to¹ through toⁿ) from data source 102a. As shown by reference number 510 in FIG. 5B, machine learning management system 102 may calculate a pairwise distance between the time series and each template of a plurality of k templates (e.g., a plurality of time series templates shown as t₁¹ through t₁^{m}, t₂¹ through t₂^{m}, and tₖ¹ through tₖ^{m}). For example, machine learning management system 102 may calculate the pairwise distance between each data point of the input time series and each value of each time series template of the plurality of time series templates. In some non-limiting embodiments or aspects, machine learning management system 102 may generate a pairwise distance matrix based on calculating the pairwise distance between the time series and each template of a plurality of templates. In some non-limiting embodiments or aspects, the pairwise distance matrix has a width equal to the length of a template, a height equal to the length of the time series, and a length equal to the number of templates (e.g., a length equal to k number of templates).

As shown by reference number 515 in FIG. 5C, machine learning management system 102 may provide the pairwise distance as a first input to a first building block of a plurality of building blocks of a residual neural network machine learning model. As further shown by reference number 520 in FIG. 5C, machine learning management system 102 may generate a first output of the first building block of the residual neural network machine learning model based on the first input.

As shown by reference number 525 in FIG. 5D, machine learning management system 102 may provide the first output as a second input to a second building block of the plurality of building blocks of the residual neural network machine learning model. As further shown by reference number 530 in FIG. 5D, machine learning management system 102 may generate a final output of the residual neural network machine learning model based on the second input.

As shown by reference number 535 in FIG. 5E, machine learning management system 102 may provide the final output of the residual neural network as an input to each output layer of a plurality of output layers of a multitask machine learning model. As further shown by reference number 540 in FIG. 5E, machine learning management system 102 may generate a first output of the multitask machine learning model using the first output layer and a second output of the multitask machine learning model using the second output layer.

As shown by reference number 545 in FIG. 5F, machine learning management system 102 may train the multitask machine learning model based on a loss function. In one example, the loss function is associated with an SGD algorithm.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method for generating a multitask machine learning model based on time series data, comprising:
receiving, with at least one processor, input time series data associated with an input time series of data points;
calculating, with at least one processor, a pairwise distance between the input time series and each time series template of a plurality of time series templates;
providing, with at least one processor, the pairwise distance as a first input to a first building block of a plurality of building blocks of a residual neural network, wherein the residual neural network has a plurality of multi-dimensional convolutional layers;
generating, with at least one processor, a first output of the first building block of the residual neural network based on the first input;
providing, with at least one processor, the first output as a second input to a second building block of the plurality of building blocks of the residual neural network;
generating, with at least one processor, a final output of the residual neural network based on the second input;
providing, with at least one processor, the final output of the residual neural network as an input to each output layer of a plurality of output layers of a multitask machine learning model, wherein the plurality of output layers comprises:
a first output layer associated with a first classification task of the multitask machine learning model, and
a second output layer associated with a second classification task of the multitask machine learning model; and
generating, with at least one processor, a first output of the multitask machine learning model using the first output layer and a second output of the multitask machine learning model using the second output layer.

2. The computer-implemented method of claim 1, wherein a building block of the plurality of building blocks of the residual neural network comprises:
a plurality of two-dimensional convolutional layers; and
a plurality of layers having a rectified linear unit activation function.

3. The computer-implemented method of claim 1, wherein an output layer of the plurality of output layers comprises:
a layer having a linear activation function, and
a layer having a softmax activation function.

4. The computer-implemented method of claim 1, wherein each output layer of the plurality of output layers has an independent set of parameters associated with a classification task of the output layer.

5. The computer-implemented method of claim 1, wherein the input time series has a first length, wherein each time series template of the time series templates has a second length, wherein the plurality of time series templates comprises a number of time series templates, and wherein calculating the pairwise distance between each data point of the input time series and each value of the time series template of the plurality of time series templates comprises:
computing a pairwise distance matrix that has a width equal to the second length, a height equal to the first length, and a length equal to the number of time series templates of the plurality of time series templates.

6. The computer-implemented method of claim 1, wherein generating the final output of the residual neural network comprises:
generating an output of a global average pooling layer based on an input to the global average pooling layer, wherein the input to the global average pooling is based on the second input to the second building block of the residual neural network.

7. The computer-implemented method of claim 1, further comprising:
training the multitask machine learning model based on a loss function, wherein the loss function is associated with a stochastic gradient (SGD) algorithm.

8. A system for generating a multitask machine learning model based on time series data, comprising at least one processor programmed or configured to:
receive input time series data associated with an input time series of data points;
calculate a pairwise distance between each data point of the input time series and each time series template of a plurality of time series templates, wherein, when calculating the pairwise distance between the input time series and each time series template of the plurality of time series templates, the at least one processor is programmed or configured to:
calculate the pairwise distance between each data point of the input time series and each value of each time series template of the plurality of time series templates;
provide the pairwise distance as a first input to a first building block of a plurality of building blocks of a residual neural network, wherein the residual neural network has a plurality of multi-dimensional convolutional layers;
generate a first output of the first building block of the residual neural network based on the first input;
provide the first output as a second input to a second building block of the plurality of building blocks of the residual neural network;
generate a final output of the residual neural network based on the second input;
provide the final output of the residual neural network as an input to each output layer of a plurality of output layers of a multitask machine learning model, wherein the plurality of output layers comprises:
a first output layer associated with a first classification task of the multitask machine learning model, and
a second output layer associated with a second classification task of the multitask machine learning model; and
generate a first output of a multitask machine learning model using the first output layer and a second output of the multitask machine learning model using the second output layer.

9. The system of claim 8, wherein a building block of the plurality of building blocks of the residual neural network comprises:
a plurality of two-dimensional convolutional layers; and
a plurality of layers having a rectified linear unit activation function.

10. The system of claim 8, wherein an output layer of the plurality of output layers comprises:
a layer having a linear activation function, and
a layer having a softmax activation function.

11. The system of claim 8, wherein each output layer of the plurality of output layers has an independent set of parameters associated with a classification task of the output layer.

12. The system of claim 8, wherein the input time series has a first length, wherein each time series template of the time series templates has a second length, wherein the plurality of time series templates comprises a number of time series templates, and wherein, when calculating the pairwise distance between each data point of the input time series and each time series template of the plurality of time series templates, the at least one processor is programmed or configured to:
compute a pairwise distance matrix that has a width equal to the second length, a height equal to the first length, and a length equal to the number of time series templates.

13. The system of claim 8, wherein, when generating the final output of the residual neural network, the at least one processor is programmed or configured to:
generate an output of a global average pooling layer based on an input to the global average pooling layer, wherein the input to the global average pooling is based on the second input to the second building block of the residual neural network.

14. The system of claim 8, wherein the at least one processor is further programmed or configured to:
train the multitask machine learning model based on a loss function, wherein the loss function is associated with a stochastic gradient (SGD) algorithm.

15. A computer program product for generating a multitask machine learning model based on time series data, the computer program product comprising at least one non-transitory computer-readable medium including one or more instructions that, when executed by at least one processor, cause the at least one processor to:
receive input time series data associated with an input time series of data points;
calculate a pairwise distance between the input time series and each time series template of a plurality of time series templates;
provide the pairwise distance as a first input to a first building block of a plurality of building blocks of a residual neural network, wherein the residual neural network has a plurality of multi-dimensional convolutional layers;
generate a first output of the first building block of the residual neural network based on the first input;
provide the first output as a second input to a second building block of the plurality of building blocks of the residual neural network;
generate a final output of the residual neural network based on the second input;
provide the final output of the residual neural network as an input to each output layer of a plurality of output layers of a multitask machine learning model, wherein the plurality of output layers comprises:
a first output layer associated with a first classification task of the multitask machine learning model, and
a second output layer associated with a second classification task of the multitask machine learning model; and
generate a first output of a multitask machine learning model using the first output layer and a second output of the multitask machine learning model using the second output layer.

16. The computer program product of claim 15, wherein a building block of the plurality of building blocks of the residual neural network comprises:
a plurality of two-dimensional convolutional layers; and
a plurality of layers having a rectified linear unit activation function.

17. The computer program product of claim 15, wherein an output layer of the plurality of output layers comprises:
a layer having a linear activation function, and
a layer having a softmax activation function.

18. The computer program product of claim 15, wherein each output layer of the plurality of output layers has an independent set of parameters associated with a classification task of the output layer.

19. The computer program product of claim 15, wherein the input time series has a first length, wherein each time series template of the time series templates has a second length, wherein the plurality of time series templates comprises a number of time series templates, and wherein the one or more instructions that cause the at least one processor to calculate the pairwise distance between each data point of the input time series and each time series template of the plurality of time series templates cause the at least one processor to:
compute a pairwise distance matrix that has a width equal to the second length, a height equal to the first length, and a length equal to the number of time series templates.

20. The computer program product of claim 15, wherein the one or more instructions that cause the at least one processor to generate the final output of the residual neural network, cause the at least one processor to:
generate an output of a global average pooling layer based on an input to the global average pooling layer, wherein the input to the global average pooling is based on the second input to the second building block of the residual neural network.
